(19) United States
(12) Patent Application Publication
(10) Pub. No.: US 2020/0002992 A1
(43) Pub. Date: Jan. 2, 2020

(54) ACTUATOR AND VEHICLE DOOR OPENING/CLOSING ACTUATOR

(71) Applicant: MITSUBA Corporation, Gunma (JP)

(72) Inventors: YOSHITAKA SEKINE, Gunma (JP); TAKASHI TAKIZAWA, Gunma (JP); TAKAHIRO SAKIYAMA, Gunma (JP); MASAMORI MOCHIZUKI, Gunma (JP)

(73) Assignee: MITSUBA Corporation, Gunma (JP)

(21) Appl. No.: 16/360,029

(22) Filed: Mar. 21, 2019

(30) Foreign Application Priority Data
Jul. 2, 2018 (JP) 2018-125894

(51) Int. Cl. E05F 15/622; B60J 5/10; F16H 25/20

(52) U.S. Cl. CPC E05F 15/622; B60J 5/101; F16H 25/20; F16H 2025/2087; E05Y 2201/72; E05Y 2900/546; F16H 2025/2075; E05Y 2201/70

(57) ABSTRACT

An actuator and a vehicle door opening/closing actuator are provided. The actuator includes a screw shaft (38) that is driven to rotate by a rotational force of a shaft (14) of a motor part (11); a nut member (58) that is fixed to an inner tube (56) and linked to the screw shaft (38) to move along the axial direction of the screw shaft along with rotation of the screw shaft; and a stopper (60) that is disposed at the other end (38b) of the screw shaft (38) on the side opposite to the motor part to prevent the nut member from coming off the screw shaft. The stopper (60) includes a regulating member (61) that elastically regulates inclination of the screw shaft (38) with respect to the axial direction. The regulating member (61) is constantly in sliding contact with the inner circumferential surface of the inner tube (56).

### CROSS REFERENCE TO RELATED APPLICATIONS

This application claims the priority benefit of Japanese Patent Application No. 2018-125894, filed on Jul. 2, 2018. The entirety of the above-mentioned patent application is hereby incorporated by reference herein and made a part of this specification.

### BACKGROUND

### Technical Field

The disclosure relates to an actuator and a vehicle door opening/closing actuator.

### Description of Related Art

A conventional structure has been used as a vehicle door opening/closing device, in which an actuator is disposed between the periphery of an opening on the vehicle body side and a tailgate that is disposed to be openable/closable on the opening, and the actuator is driven to extend or contract in the axial direction so as to open or close the tailgate (see Patent Document 1, for example).

The actuator of Patent Document 1 includes a tubular first housing and a second housing that is fitted to the inner circumferential surface of the first housing on one end side to protrude from or retract into the first housing. In addition, the actuator includes a motor that is disposed in the first housing on the other end side, and a drive shaft (screw shaft) that is driven to rotate by a rotational force of the motor. The drive shaft is arranged in the first housing and the second housing along the axial direction. Moreover, an end of the drive shaft on the motor side is rotatably supported via a bearing. A driven part (nut member) is screwed to the drive shaft. Further, the driven part is fixed to an inner tube disposed on the inner side of the second housing in the radial direction and is not rotatable with respect to the drive shaft.

With such a configuration, the driven part slides along the axial direction of the drive shaft as the drive shaft rotates. Then, the inner tube, to which the driven part is fixed, and the second housing integrated with the inner tube move and protrude from or retract into the first housing. Since the second housing and the inner tube slide with respect to the drive shaft together with the driven part, the tip side of the drive shaft, which is on the side opposite to the motor, is not supported via a bearing or the like. In other words, the drive shaft is cantilevered.

### RELATED ART

### Patent Document

[Patent Document 1] Japanese Laid-open No. 2017-30501

### SUMMARY

Here, because the drive shaft is cantilevered, the load that accompanies the movement of the driven shaft may cause the drive shaft to slightly incline with respect to the axial direction. In such a case, the tip part of the drive shaft may collide with the inner tube and generate noise (rattle sound).

Therefore, the disclosure provides an actuator and a vehicle door opening/closing actuator that can reduce noise during driving.

In view of the above, an actuator according to the disclosure includes a tubular first housing; a tubular second housing fitted to an inner circumferential surface of the first housing on one end side to protrude from or retract into the first housing; a motor disposed in the first housing on the other end side and including a rotation shaft; a drive shaft disposed in the first housing and the second housing to be driven to rotate by a rotational force of the rotation shaft of the motor; a driven part fixed to an inner tube disposed on an inner side of the second housing in a radial direction and linked to the drive shaft to move along an axial direction of the drive shaft along with rotation of the drive shaft; and a stopper disposed on a tip part of the drive shaft on a side opposite to the motor to prevent the driven part from coming off the drive shaft, wherein the stopper includes a regulating member that elastically regulates inclination of the drive shaft with respect to the axial direction, and the regulating member is constantly in sliding contact with an inner circumferential surface of the inner tube.

By disposing the regulating member of the stopper disposed on the tip part of the drive shaft to be constantly in sliding contact with the inner circumferential surface of the inner tube, it is as if configured in a manner that the drive shaft is supported on two sides and thereby it is possible to prevent the drive shaft from inclining with respect to the axial direction. Therefore, the tip part of the drive shaft does not collide with the inner circumferential surface of the inner tube, and the noise during driving of the actuator can be reduced. In addition, since the regulating member elastically regulates the inclination of the drive shaft, the sliding friction resistance between the inner circumferential surface of the inner tube and the regulating member can be reduced as much as possible. Therefore, it is possible to lower the load on the motor as much as possible while reducing the noise during driving of the actuator.

In the actuator of the disclosure, the regulating member is a rubber that is in sliding contact with an entire circumference of the inner circumferential surface of the inner tube.

With such a configuration, it is possible to elastically regulate the inclination of the drive shaft with respect to the axial direction by the regulating member with a simple structure. In addition, since the rubber is in sliding contact with the entire circumference of the inner circumferential surface of the inner tube, the inclination of the drive shaft can be reliably prevented regardless of the inclination direction of the drive shaft.

The actuator of the disclosure includes a plurality of recesses formed on an outer circumferential surface of the regulating member or a plurality of through holes formed in the regulating member, or includes both the plurality of recesses and the plurality of through holes.

With such a configuration, the spaces inside the inner tube are not completely separated by the stopper. In other words, the air in the two spaces separated by the stopper can move to either side via the recesses or the through holes of the stopper. Therefore, it is possible to prevent the air inside the inner tube from being compressed by the stopper, thereby preventing the actuator from malfunctioning.

In the actuator of the disclosure, the regulating member includes a fixing part fixed to the tip part of the drive shaft; a sliding contact part formed in an annular shape to surround a periphery of the fixing part and being in sliding contact with the inner circumferential surface of the inner tube; and an elastic member disposed between the fixing part and the sliding contact part.

With such a configuration, it is possible to elastically regulate the inclination of the drive shaft with respect to the axial direction by the regulating member with a simple structure. Further, the force for suppressing the inclination of the drive shaft can be easily adjusted by adjusting the elastic force of the elastic member. Therefore, the regulating member has good usability.

In the actuator of the disclosure, the elastic member is a compression coil spring.

With such a configuration, the configuration of the elastic member can be simplified and the manufacturing cost of the regulating member can be reduced.

A vehicle door opening/closing actuator according to the disclosure uses the above-described actuator for opening/closing a door that is disposed to open/close an opening.

With such a configuration, it is possible to reduce the noise during driving of the vehicle door opening/closing actuator.

According to the disclosure, by disposing the regulating member of the stopper disposed on the tip part of the drive shaft to be constantly in sliding contact with the inner circumferential surface of the inner tube, it is as if configured in a manner that the drive shaft is supported on two sides and thereby it is possible to prevent the drive shaft from inclining with respect to the axial direction. Therefore, the tip part of the drive shaft does not collide with the inner circumferential surface of the inner tube, and the noise during driving of the actuator can be reduced.

### BRIEF DESCRIPTION OF THE DRAWINGS

FIG. 1 is a perspective view showing an example of an automobile provided with the vehicle door opening/closing actuator in the first embodiment of the disclosure.

FIG. 2 is a perspective view of the vehicle door opening/closing actuator in the first embodiment of the disclosure.

FIG. 3 is a cross-sectional view along the axial direction of the vehicle door opening/closing actuator in the first embodiment of the disclosure.

FIG. 4 is a partially enlarged cross-sectional view of one side of the vehicle door opening/closing actuator in the first embodiment of the disclosure.

FIG. 5 is a partially enlarged cross-sectional view of the other side of the vehicle door opening/closing actuator in the first embodiment of the disclosure.

FIG. 6 is a plan view of the regulating member in the first embodiment of the disclosure, as viewed from the axial direction.

FIG. 7 is a cross-sectional view along the axial direction showing a state during extension/contraction of the vehicle door opening/closing actuator in the first embodiment of the disclosure.

FIG. 8 is a plan view of the regulating member in a modified example of the first embodiment of the disclosure, as viewed from the axial direction.

FIG. 9 is a plan view of the regulating member in the second embodiment of the disclosure, as viewed from the axial direction.

### DESCRIPTION OF THE EMBODIMENTS

Next, embodiments of the disclosure will be described with reference to the drawings.

### First Embodiment

### (Vehicle Door Opening/Closing Actuator)

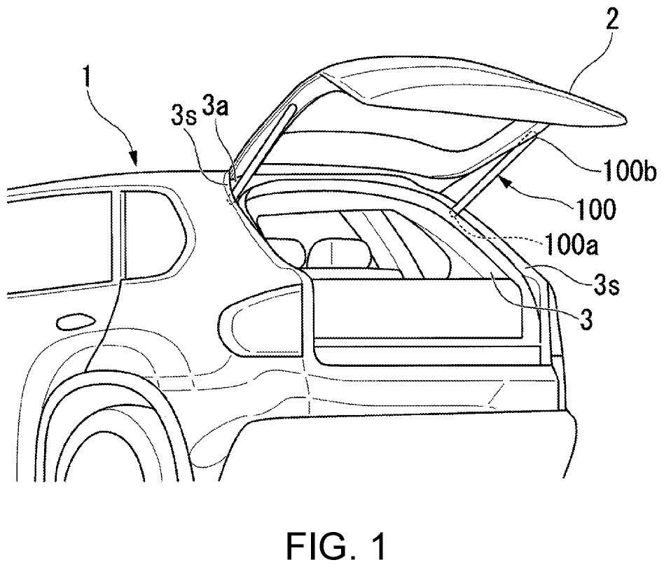

FIG. 1 is a perspective view showing an example of an automobile 1 provided with a vehicle door opening/closing actuator 100 (hereinafter, simply referred to as “actuator 100”) in the first embodiment of the disclosure. As shown in FIG. 1, the actuator 100 is for opening/closing, for example, a tailgate (door) 2 of the automobile 1. The tailgate 2 is disposed on an upper part 3a of an opening 3 formed at the rear part of the vehicle body of the automobile 1 to open/close the opening 3 via a hinge mechanism (not shown).

The actuator 100 is disposed respectively on the left and right sides or on one side of the opening 3. One end 100a of the actuator 100 is rotatably connected to an outer frame 3s of the opening 3 via a ball stud (not shown). In addition, the other end 100b of the actuator 100 is rotatably connected to the tailgate 2 via a ball stud (not shown). In the following description, the side of the opening 3 of the actuator 100 may be referred to as one end side or one side, and the side of the tailgate 2 may be referred to as the other end side or the other side.

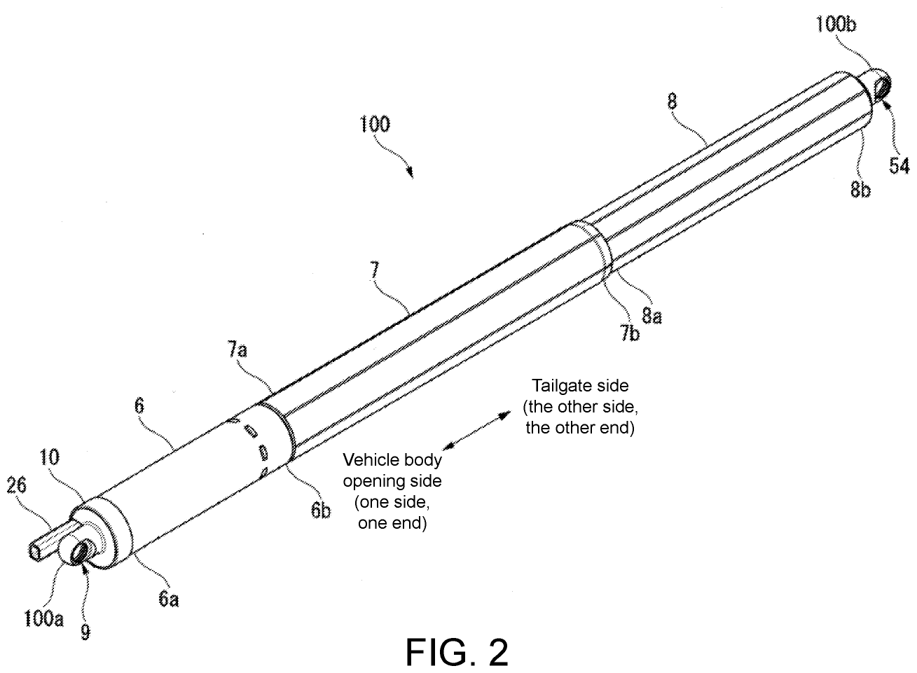

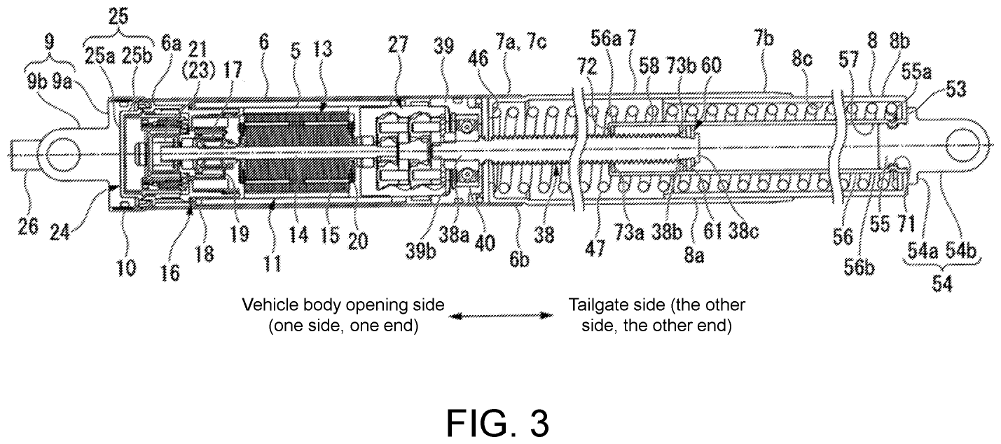

FIG. 2 is a perspective view of the actuator 100. FIG. 3 is a cross-sectional view along the axial direction of the actuator 100. As shown in FIG. 2 and FIG. 3, the actuator 100 is a rod-shaped body including three housings 6 to 8, which are a substantially tubular first housing 6 (corresponding to the first housing in the claims); a substantially tubular second housing 7 (corresponding to the first housing in the claims) having one end 7a (the left end in FIG. 2 and FIG. 3) fitted and fixed to the inner circumferential surface of the first housing 6 at the other end 6b (the right end in FIG. 2 and FIG. 3); and a substantially tubular third housing 8 (corresponding to the second housing in the claims) fitted to the inner circumferential surface of the second housing 7 at the other end 7b so as to protrude therefrom or retract thereinto.

In the following description, the direction along the central axis of each of the housings 6 to 8 is simply referred to as the axial direction, the radial direction of each of the housings 6 to 8 is simply referred to as the radial direction, and the direction along the outer circumferential surface of each of the housings 6 to 8 is simply referred to as the circumferential direction.

### (First Housing)

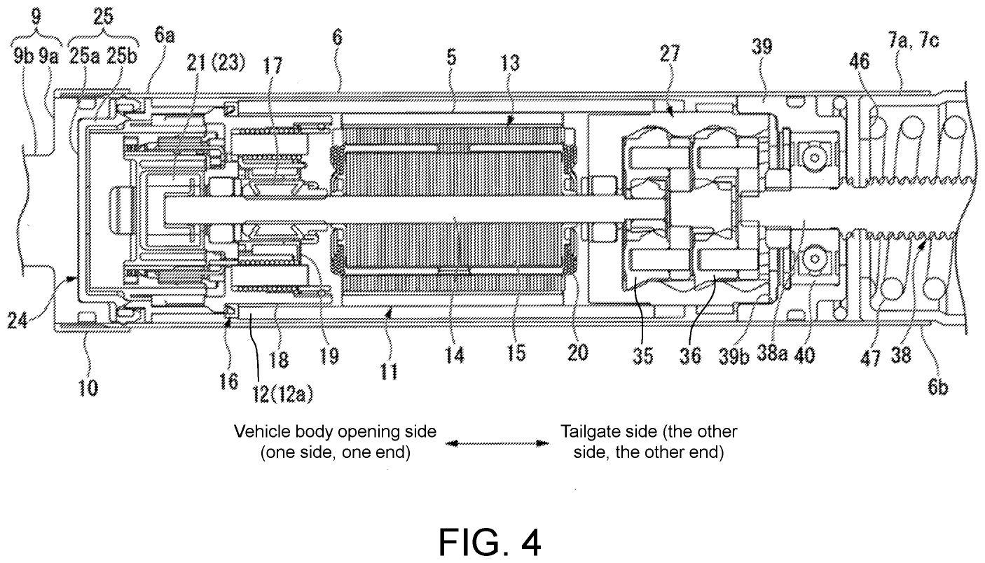

FIG. 4 is a partially enlarged cross-sectional view of one side (the left side in FIG. 3) of the actuator 100. As shown in FIG. 4, the first housing 6 is for example made of a metal material such as iron. A joint part 9, which is to be connected to the ball stud (not shown) disposed on the outer frame 3s (see FIG. 1) of the opening 3, is disposed at one end 6a of the first housing 6. The joint part 9 includes a substantially disk-shaped plate part 9a and a socket part 9b that are integrally molded. The plate part 9a is fitted into the one end 6a of the first housing 6. The socket part 9b protrudes from the plate part 9a toward one side (the outer side) in the axial direction of the first housing 6. The plate part 9a is formed with an insertion hole (not shown) for inserting a harness cover 26 (to be described later).

Moreover, a substantially tubular end cover 10 is attached to the one end 6a of the first housing 6. The end cover 10 is fitted and fixed to the outer circumferential surface of the first housing 6 at the one end 6a. Further, the end cover 10 is fitted and fixed to the outer circumferential surface of the plate part 9a of the joint part 9. Thus, it is possible to prevent the joint part 9 from coming off from the one end 6a of the first housing 6.

### (Motor Part)

A motor part 11 is housed in the first housing 6. The motor part 11 includes a substantially tubular yoke 12, a magnet 5 fixed to the inner circumferential surface of the yoke 12, an armature 13 rotatably disposed on the inner side of the yoke 12 in the radial direction, and a brush holder unit 16 for supplying power to the armature 13. The yoke 12 is made of a metal that has conductivity. The outer diameter of the yoke 12 is set to be smaller than the inner diameter of the first housing 6 by a predetermined dimension.

The armature 13 disposed on the inner side of the yoke 12 in the radial direction includes a shaft 14 disposed to be rotatable in the yoke 12, an armature core 15 composed of a magnetic material and externally fitted and fixed to the shaft 14, a coil 20 wound around the armature core 15, and a commutator 17 which is externally fitted and fixed to the shaft 14 and adjacent to the armature core 15 and to which a terminal portion of the coil 20 is connected.

The shaft 14 extends along the axial direction at the center of the yoke 12 in the radial direction. One end of the shaft 14 is inserted through the brush holder unit 16 to be rotatably supported by the brush holder unit 16. Further, the other end of the shaft 14 is connected to a deceleration gear part 27 (to be described later). Moreover, a sensor magnet 21 is attached to one end of the shaft 14. The sensor magnet 21 constitutes one part of a rotational position detection device 23 for detecting the rotational position of the shaft 14.

The brush holder unit 16 for supplying power to the armature 13 includes a brush holder 18 and a brush 19. The brush holder 18 is made of a resin and is caulked and fixed to one end 12a of the yoke 12. The brush 19 is held by the brush holder 18. The brush 19 is in sliding contact with the commutator 17. Further, the brush 19 is electrically connected to an external power supply (for example, a battery) via a harness (not shown). Thus, the power of the external power supply is supplied to the coil 20 via the brush 19 and the commutator 17.

In addition, a sensor substrate (not shown) is disposed on the brush holder 18 so as to be in the radial direction with the outer circumferential surface of the sensor magnet 21 disposed on the shaft 14. The sensor substrate constitutes the other part of the rotational position detection device 23. A magnetic detection element (not shown) for detecting a magnetic change on the outer circumferential surface of the sensor magnet 21 is mounted on the sensor substrate. Thus, the rotational position of the shaft 14 can be detected by the rotational position detection device 23.

A seal part 24 is attached to the brush holder unit 16 on the side of the joint part 9. The seal part 24 is made of a rubber-based material that has elasticity. The seal part 24 has a seal main body 25 that is formed in a substantially bottomed cylindrical shape so as to cover the brush holder unit 16 from the side of the joint part 9. That is, the seal main body 25 is constituted by a bottom 25a and a substantially tubular circumferential wall 25b. The bottom 25a is held by the brush holder 18 and the plate part 9a of the joint part 9. The circumferential wall 25b extends from the outer circumferential edge of the bottom 25a toward the side opposite to the joint part 9 and is interposed between the brush holder unit 16 and the inner circumferential surface of the first housing 6.

On the bottom 25a of the seal main body 25, the harness cover 26 is formed and protrudes toward one side (the outer side) in the axial direction. The harness cover 26 is formed in a substantially pipe shape and communicates the inside and the outside of the seal main body 25. The harness (not shown) for electrically connecting the external power supply (not shown) and the brush 19 is inserted through the harness cover 26 configured as described above.

With such a configuration, when the power of the external power supply is supplied to the coil 20 via the harness (not shown), the brush 19, and the commutator 17, a magnetic field is formed in the armature core 15. Then, the magnetic attractive force and repulsive force generated between the magnetic field and the magnet fixed to the yoke 12 cause the shaft 14 to rotate around its central axis. Further, the sensor magnet 21 rotates integrally with the shaft 14. The magnetic change generated when the sensor magnet 21 rotates is detected by the rotational position detection device 23, and the rotational position of the shaft 14 is detected.

### (Deceleration Gear Part)

The deceleration gear part 27 connected to the other end of the shaft 14 is configured as a two-stage planetary deceleration mechanism that has a first stage planetary gear part 35 and a second stage planetary gear part 36. Then, the deceleration gear part 27 decelerates the rotation of the shaft 14 in two stages with the first stage planetary gear part 35 and the second stage planetary gear part 36 and outputs it. The output of the deceleration gear part 27 is transmitted to a screw shaft 38 connected to the second stage planetary gear part 36.

The screw shaft 38 is driven to rotate around the central axis of the shaft 14 in the motor part 11. One end 38a of the screw shaft 38 on the side of the deceleration gear part 27 is rotatably supported by a bearing holder 39. Further, the other end 6b of the first housing 6 on the side of the deceleration gear part 27 protrudes toward the other side (the right side in FIG. 4) with respect to the bearing holder 39.

The bearing holder 39 is formed in a substantially annular shape and is fitted and fixed to the inner circumferential surface of the first housing 6 on the other end side (the right side in FIG. 4) with respect to the deceleration gear part 27 by caulking. A bearing 40 is inserted or press-fitted to the inner circumferential surface of the bearing holder 39. Through the bearing 40, the bearing holder 39 rotatably supports one end 38a of the screw shaft 38. In addition, a recess 39b is formed on an end surface of the bearing holder 39 on the side of the deceleration gear part 27 in most of the center in the radial direction. The other end side of the deceleration gear part 27 is inserted into the recess 39b.

The screw shaft 38 is extended to protrude from the bearing holder 39 toward the other side in the axial direction. The screw shaft 38 is a so-called trapezoidal screw and is formed with a thread on the outer circumferential surface. The second housing 7 is disposed to cover the periphery of the screw shaft 38 configured as described above.

### (Second Housing)

As shown in FIG. 3 and FIG. 4, the second housing 7 is made of a resin material or the like. The outer diameter of the second housing 7 is set to be substantially the same as the outer diameter of the first housing 6 except for the side of one end 7a that is fitted to the other end 6b of the first housing 6. The diameter on the side of the one end 7a of the second housing 7 is reduced by a step to form a diameter-reduced part 7c. The diameter-reduced part 7c is press-fitted and fixed to the other end 6b of the first housing 6. Thus, the first housing 6 and the second housing 7 are integrated with each other in a state where the outer circumferential surface of the first housing 6 and the outer circumferential surface of the second housing 7 are substantially flush with each other.

In addition, the second housing 7 is formed so that, in a state where the side of the one end 7a of the second housing 7 is fitted and fixed to the other end 6b of the first housing 6, the other end 7b of the second housing 7 slightly protrudes with respect to the other end (tip part) 38b of the screw shaft 38. Furthermore, the diameter-reduced part 7c of the second housing 7 is set to a length so that the diameter-reduced part 7c does not contact the bearing holder 39 when it is press-fitted into the other end 6b of the first housing 6. An inner flange 46 bent to the inner side in the radial direction is formed at one end 7a of the second housing 7. One end of a coil spring 47 (to be described later) is brought into contact with the inner flange 46.

The coil spring 47 is disposed in the second housing 7. The coil spring 47 is formed in a spiral shape to follow the inner circumferential surface of the second housing 7. One end of the coil spring 47 is in contact with the inner flange 46 of the second housing 7. Moreover, the free length of the coil spring 47 is set to be sufficiently longer than the length of the second housing 7. Therefore, in a state where one end of the coil spring 47 is brought into contact with the inner flange 46 of the second housing 7, the other end of the coil spring 47 protrudes from the other end 7b of the second housing 7.

### (Third Housing)

The substantially tubular third housing 8 disposed to protrude from or retract into the other end 7b of the second housing 7 has an outer diameter that is slightly smaller than the outer diameter of the second housing 7. Then, the side of one end 8a of the third housing 8 on the side of the motor part 11 is inserted into the other end 7b of the second housing 7. Thus, the third housing 8 can protrude from or retract into the other end 7b of the second housing 7. Then, the other end side of the coil spring 47 is housed in the third housing 8. An inner flange 53 bent to the inner side in the radial direction is formed at the other end 8b of the third housing 8. The other end of the coil spring 47 is brought into contact with the inner surface side of the inner flange 53 and a joint part 54 is brought into contact with the outer surface side.

The joint part 54 is connected to the ball stud (not shown) disposed on the tailgate 2 (see FIG. 1). The joint part 54 includes a substantially disk-shaped plate part 54a and a socket part 54b that are integrally molded. The plate part 54a is in contact with the inner flange 53 of the third housing 8. The socket part 54b protrudes from the plate part 54a toward the other side (the outer side) in the axial direction.

The outer diameter of the plate part 54a is set to be slightly smaller than the outer diameter of the third housing 8. Moreover, a substantially cylindrical fixing protrusion 55, which protrudes into the third housing 8 via the inner flange 53 of the third housing 8, is integrally molded at substantially the center of the plate part 54a in the radial direction. An engagement groove 55a is formed over the entire circumference at substantially the center of the fixing protrusion 55 in the axial direction. The other end 56b of an inner tube 56 is fixed to the fixing protrusion 55 configured as described above.

### (Inner Tube)

The third housing 8 includes the substantially tubular inner tube 56 that is disposed on the inner side of the third housing 8 in the radial direction. The inner tube 56 is formed by drawing aluminum, for example. The outer circumferential surface of the other end 56b of the inner tube 56 is fitted to the inner circumferential surface of the inner flange 53 of the third housing 8. The other end side of the coil spring 47 is housed in a space formed between the inner tube 56 and the inner circumferential surface 8c of the third housing 8. In addition, the outer circumferential surface of the fixing protrusion 55 of the joint part 54 is fitted to the inner circumferential surface 57 of the other end 56b of the inner tube 56. An engagement protrusion 71 is formed over the entire circumference at the other end 56b of the inner tube 56 to be fitted to the engagement groove 55a of the fixing protrusion 55. As a result, the other end 56b of the inner tube 56 is fixed to the fixing protrusion 55.

The length of the inner tube 56 in the axial direction is set to be slightly larger than the length of the third housing 8 in the axial direction. Therefore, one end 56a of the inner tube 56 faces the inside of the second housing 7 via one end 8a of the third housing 8. An inner flange 72 bent to the inner side in the radial direction is formed at one end 56a of the inner tube 56. The screw shaft 38 is inserted to the inner side of the inner flange 72 in the radial direction. Further, a nut member 58 is fixed to the inner circumferential surface of the inner tube 56 on the inner side (the other side) of the inner flange 72.

The movement of the nut member 58 in the axial direction is regulated by two retaining rings 73a and 73b that are fixed to the inner circumferential surface of the inner tube 56 arranged on two sides of the nut member 58 in the axial direction. Thus, the nut member 58 is fixed to the inner tube 56. The side of the other end 38b of the screw shaft 38 is screwed to the nut member 58.

Here, the nut member 58 is fixed to the inner tube 56, and furthermore, the inner tube 56 is fixed to the joint part 54. The joint part 54 is connected to the ball stud (not shown) disposed on the tailgate 2 (see FIG. 1). Therefore, when the screw shaft 38 is rotated, the nut member 58 does not rotate with the screw shaft 38. Therefore, when the screw shaft 38 is rotated, the nut member 58 moves along the screw shaft 38.

### (Stopper)

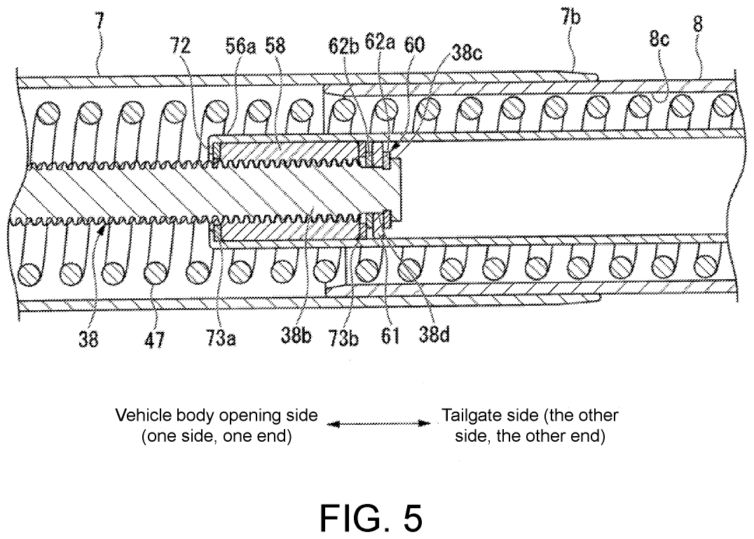

FIG. 5 is a partially enlarged cross-sectional view of the other side (the right side in FIG. 3) of the actuator 100. As shown in FIG. 5, a buckled and deformed outer flange part 38c is formed at the other end 38b of the screw shaft 38. At the other end 38b of the screw shaft 38, a portion before where the outer flange part 38c is formed is an attaching part 38d which has a substantially circular cross section with no trapezoidal screw formed thereon. A stopper 60 is disposed in the attaching part 38d. The stopper 60 has a function of preventing the nut member 58 from being removed from the screw shaft 38 and a function of preventing inclination of the screw shaft 38 with respect to the axial direction.

The stopper 60 includes a regulating member 61 and two retaining rings 62a and 62b. The regulating member 61 is made of rubber that is elastically deformable, and has a substantially annular shape fitted to the outer circumferential surface of the screw shaft 38. The two retaining rings 62a and 62b are disposed on two sides of the regulating member 61 in the axial direction and are attached to the screw shaft 38.

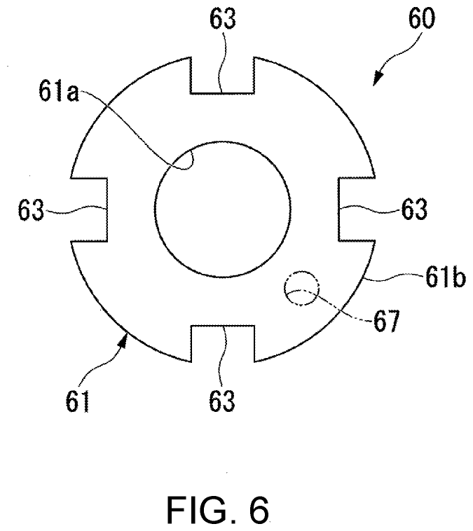

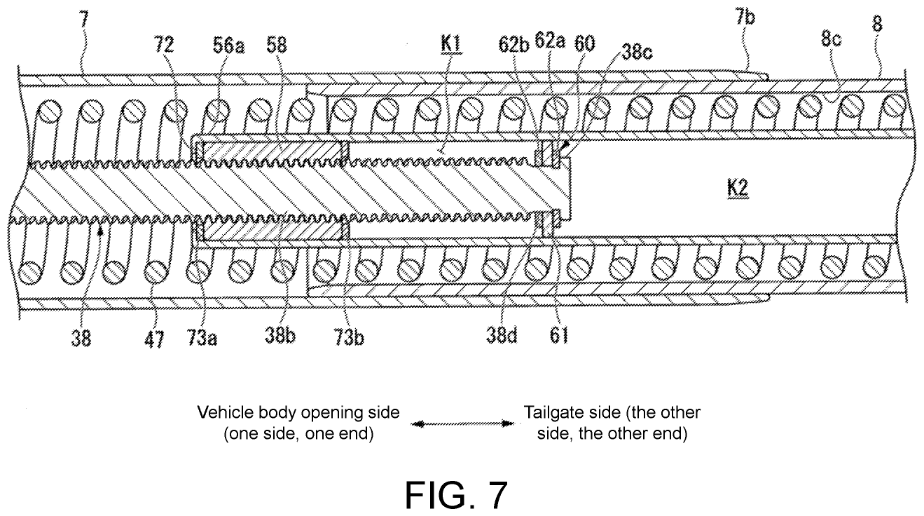

FIG. 6 is a plan view of the regulating member 61 as viewed from the axial direction. As shown in FIG. 5 and FIG. 6, the outer diameter of the regulating member 61 is set to be substantially the same as the inner diameter of the inner tube 56. On the other hand, the diameter of a through hole 61a, which is formed at the center of the regulating member 61 in the radial direction and through which the screw shaft 38 is inserted, is set to be substantially the same as the outer diameter of the attaching part 38d of the screw shaft 38. Further, a plurality of (the first embodiment) recesses 63 are formed on the outer circumferential surface 61b of the regulating member 61. The recesses 63 are arranged at equal intervals in the circumferential direction. In addition, the recess 63 is formed in a substantially rectangular shape as viewed from the axial direction. That is, the recess 63 has a bottom side 63a and two inner sides 63b that are arranged at two ends of the bottom side 63 a in the circumferential direction and face each other in the circumferential direction. With formation of the recesses 63, two spaces K1 and K2 (see FIG. 7) in the inner tube 56 separated by the regulating member 61 are communicated with each other via the recesses 63.

Here, the length of the third housing 8 is set to such a length that, in a state where the nut member 58 is positioned closest to the side of the other end 38b of the screw shaft 38, the coil spring 47 is slightly compressed to an extent by the inner flange 53. In other words, the coil spring 47 constantly urges the third housing 8 in a direction to protrude from the second housing 7. Moreover, the third housing 8 is connected to the screw shaft 38 via the inner tube 56 and the nut member 58, and the third housing 8 is regulated from moving in the direction to protrude from the second housing 7. Therefore, the coil spring 47 constantly urges the inner flange 46 of the second housing 7 toward the side of the motor part 11.

### (Operation of the Vehicle Door Opening/Closing Actuator)

Next, the operation of the actuator 100 will be described. When the power of the external power supply (not shown) is supplied to the motor part 11 through the operation of an operator, and the shaft 14 of the motor part 11 is rotationally driven, the shaft 14 rotates. Further, the rotation of the shaft 14 is decelerated by the deceleration gear part 27 and transmitted to the screw shaft 38. When the screw shaft 38 rotates, the nut member 58 slides along the screw shaft 38. Since the nut member 58 is fixed to the inner tube 56 of the third housing 8, the third housing 8 protrudes from or retracts into the second housing 7, and the actuator 100 extends or contracts.

When the third housing 8 retracts into the second housing 7, the tailgate 2 (see FIG. 1) disposed on the opening 3 of the automobile 1 is closed. On the other hand, when the third housing 8 protrudes from the second housing 7, the tailgate 2 disposed on the opening 3 of the automobile 1 is opened. At this time, even if the operation of the motor part 11 is stopped while the actuator 100 is extended, the state that the third housing 8 protrudes from the second housing 7 is maintained by the urging force of the coil spring 70.

### (Function of the Stopper)

Next, the function of the stopper 60 will be described. The stopper 60 can cooperate with the outer flange part 38c formed on the screw shaft 38 and the retaining ring 62a disposed on the side of the outer flange part 38c among the two retaining rings 62a and 62b to reliably prevent the regulating member 61 from coming off the screw shaft 38. As a result, it is possible to reliably prevent the nut member 58 from coming off the screw shaft 38.

In addition, the outer diameter of the regulating member 61 that constitutes the stopper 60 is set to be substantially the same as the inner diameter of the inner tube 56. On the other hand, the diameter of the through hole 61a, which is formed at the center of the regulating member 61 in the radial direction and through which the screw shaft 38 is inserted, is set to be substantially the same as the outer diameter of the attaching part 38d of the screw shaft 38. Therefore, the regulating member 61 does not rattle against the inner tube 56 in the radial direction. The other end 38b of the screw shaft 38 does not rattle against the regulating member 61 in the radial direction. Furthermore, the regulating member 61 is made of rubber that is elastically deformable. In other words, the inclination of the screw shaft 38 with respect to the axial direction is elastically regulated by the regulating member 61.

Besides, because the outer diameter of the regulating member 61 is formed to be substantially the same as the inner diameter of the inner tube 56, it is constantly in sliding contact with the inner circumferential surface of the inner tube 56 as the nut member 58 slides along the screw shaft 38. Since the regulating member 61 is made of rubber that is elastically deformable, the sliding friction resistance between the inner circumferential surface of the inner tube 56 and the outer circumferential surface 61b of the regulating member 61 is reduced as much as possible.

FIG. 7 is a cross-sectional view along the axial direction showing a state during the extension/contraction of the actuator 100. Here, as shown in FIG. 7, the internal space of the inner tube 56 is separated into two spaces K1 and K2 by the regulating member 61 while the actuator 100 extends/contracts. Since the outer diameter of the regulating member 61 is formed to be substantially the same as the inner diameter of the inner tube 56, if the regulating member 61 is not formed with the recesses 63, one of the spaces K1 and K2 will be compressed as the nut member 58 (the inner tube 56) slides.

In the first embodiment, however, a plurality of recesses 63 are formed on the outer circumferential surface 61b of the regulating member 61. Therefore, the two spaces K1 and K2 separated by the regulating member 61 in the inner tube 56 communicate with each other via the recesses 63. Thus, it is possible to prevent compression of one of the spaces K1 and K2 caused by the sliding movement of the nut member 58 (the inner tube 56), thereby preventing the actuator 100 from malfunctioning.

In the first embodiment described above, the regulating member 61 made of rubber is disposed in the stopper 60 that is for preventing the nut member 58 from coming off the screw shaft 38. The outer circumferential surface 61b of the regulating member 61 is constantly in sliding contact with the inner circumferential surface of the inner tube 56. Therefore, it is as if configured in a manner that the screw shaft 38 is supported on two sides by the bearing 40 and the stopper 60. Accordingly, it is possible to prevent the screw shaft 38 from inclining with respect to the axial direction with a simple structure. Thus, the other end 38b of the screw shaft 38 does not collide with the inner circumferential surface of the inner tube 56, and the noise during driving of the actuator 100 can be reduced. In addition, since the regulating member 61 elastically regulates the inclination of the screw shaft 38, the sliding friction resistance between the inner circumferential surface of the inner tube 56 and the regulating member 61 can be reduced as much as possible. Therefore, it is possible to lower the load on the motor part 11 as much as possible while reducing the noise during driving of the actuator 100 with a simple structure.

Furthermore, the regulating member 61 is formed in a substantially annular shape and the entire outer circumferential surface 61b, except for the recesses 63, is in sliding contact with the inner circumferential surface of the inner tube 56. Therefore, it is possible to reliably prevent the inclination of the screw shaft 38 regardless of the inclination direction of the screw shaft 38. A plurality of recesses 63 are formed on the outer circumferential surface 61b of the regulating member 61. Therefore, the spaces inside the inner tube 56 are not completely separated by the stopper 60 (the regulating member 61). Therefore, it is possible to prevent the air inside the inner tube 56 from being compressed by the stopper 60, thereby preventing the actuator 100 from malfunctioning.

The first embodiment described above illustrates that the entire outer circumferential surface 61b, except for the recesses 63, of the regulating member 61 is in sliding contact with the inner circumferential surface of the inner tube 56. However, the disclosure is not limited thereto, and it suffices if at least a part of the outer circumferential surface 61b of the regulating member 61 is constantly in sliding contact with the inner circumferential surface of the inner tube 56. With such a configuration, when the inclination direction of the screw shaft 38 with respect to the axial direction is always constant, the noise during driving of the actuator 100 can be reduced.

### Modified Example of the First Embodiment

The first embodiment described above illustrates that the regulating member 61 is made of rubber that is elastically deformable. However, the disclosure is not limited thereto, and the regulating member 61 may be configured as follows.

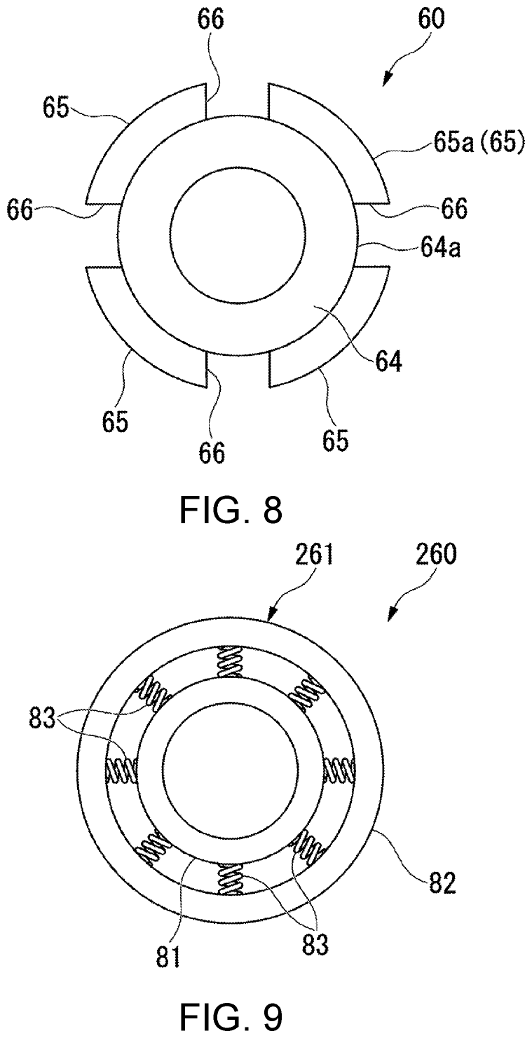

FIG. 8 is a plan view of the regulating member 61 in a modified example of the first embodiment, as viewed from the axial direction. As shown in FIG. 8, the regulating member 61 is formed by integrally molding a plurality of (4 in this modified example) protrusions 65, which are made of rubber that is elastically deformable and are disposed on the outer circumferential surface 64a of a stopper main body 64 made of metal. The stopper main body 64 is formed in a substantially annular shape and is fitted and fixed to the outer circumferential surface of the attaching part 38d of the screw shaft 38.

The protrusion 65 is formed in an arc shape, as viewed from the axial direction, along the outer circumferential surface 64a of the stopper main body 64. In addition, the protrusions 65 are arranged at equal intervals in the circumferential direction. Therefore, the regulating member 61 as a whole has a shape with a plurality of (4 in this modified example) recesses 66 formed between the adjacent protrusions 65 in the circumferential direction. Furthermore, the protrusion 65 is formed in such a size that the tip end surface 65a on the outer side in the radial direction is constantly in sliding contact with the inner circumferential surface of the inner tube 56. Thus, the modified example described above can achieve the same effect as the above-described first embodiment.

The modified example of the first embodiment described above illustrates that the protrusions 65 are arranged at equal intervals in the circumferential direction. However, the disclosure is not limited thereto, and it suffices if the protrusion 65 is disposed on at least a part of the outer circumferential surface 64a of the stopper main body 64. With such a configuration, when the inclination direction of the screw shaft 38 with respect to the axial direction is always constant, the noise during driving of the actuator 100 can be reduced.

Further, the first embodiment and the modified example of the first embodiment described above illustrate that the regulating member 61 is formed with the recesses 63, 66. However, the disclosure is not limited thereto, and a through hole (for example, the through hole 67 indicated by a two-dot chain line in FIG. 6) may be formed to penetrate the regulating member 61 in the thickness direction. Furthermore, both the through hole and the recesses 63 and 66 may be formed. That is, it suffices if the regulating member 61 can be constantly in sliding contact with the inner circumferential surface of the inner tube 65 and can communicate the two spaces K1 and K2 separated by the regulating member 61 in the inner tube 65.

In addition, the first embodiment and the modified example of the first embodiment described above illustrate that the regulating member 61 is formed with four recesses 63, 66. However, the disclosure is not limited thereto, and the number of the recesses 63, 66 can be set as desired.

### Second Embodiment

Next, the second embodiment will be described based on FIG. 9 with reference to FIG. 3 and FIG. 5. Here, the only difference between the first embodiment and the second embodiment is that the regulating member 61 of the stopper 60 of the first embodiment and a regulating member 261 of a stopper 260 of the second embodiment have different configurations. Therefore, only the regulating member 261 of the second embodiment will be described below, and the description of other configurations will be omitted.

FIG. 9 is a plan view of the regulating member 261 of the second embodiment, as viewed from the axial direction. As shown in FIG. 9, the regulating member 261 includes a fixing part 81, a sliding contact part 82, and a plurality of coil springs 83. The fixing part 81 has a substantially annular shape and is fitted and fixed to the outer circumferential surface of the attaching part 38d of the screw shaft 38. The sliding contact part 82 is formed in a substantially annular shape to surround the periphery of the fixing part 81 and is in sliding contact with the inner circumferential surface of the inner tube 56. The coil springs 83 are disposed between the fixing part 81 and the sliding contact part 82.

The fixing part 81 and the sliding contact part 82 are made of metal or the like. The fixing part 81 and the sliding contact part 82 are arranged on concentric circles. The outer diameter of the sliding contact part 82 is set to be substantially the same as the inner diameter of the inner tube 56. The coil springs 83 are arranged along the radial direction. In addition, the coil springs 83 are arranged at equal intervals in the circumferential direction. In other words, the coil springs 83 are arranged radially. In this way, the arranged coil springs 83 are slightly compressed respectively. That is, the fixing part 81 and the sliding contact part 82 are urged in a direction away from each other by the coil springs 83.

The second embodiment described above can achieve the same effect as the first embodiment. In addition to the above, in the regulating member 261, a gap is formed between the fixing part 81 and the sliding contact part 82. With this gap, it is possible to communicate the two spaces K1 and K2 separated by the regulating member 261 in the inner tube 65, as in the first embodiment and the modified example described above, without forming the recesses 63 or the like in the regulating member 61. Moreover, while the sliding contact part 82 which is in sliding contact with the inner tube 56 is made of metal, the regulating member 261 can elastically regulate the inclination of the screw shaft 38 with respect to the axial direction. Therefore, it is possible to suppress the product life from decreasing due to abrasion of the regulating member 261 or the like.

The second embodiment described above illustrates that the fixing part 81 and the sliding contact part 82 are urged in a direction away from each other by the coil springs 83. However, the disclosure is not limited thereto, and various elastic members can be adopted in place of the coil springs 83.

In addition, the disclosure is not limited to the above-described embodiments, and various modifications may be added to the above-described embodiments without departing from the spirit of the disclosure. For example, the embodiments described above illustrate that the actuator 100 is a vehicle door opening/closing actuator 100 for opening/closing, for example, the tailgate 2 of the automobile 1. However, the disclosure is not limited thereto, and the actuator 100 may be applied to various devices.

Moreover, the embodiments described above illustrate that the rotational force of the shaft 14 of the motor part 11 is transmitted to the screw shaft 38 via the deceleration gear part 27. However, the disclosure is not limited thereto, and the screw shaft 38 may be directly connected to the shaft 14. In that case, the bearing 40 disposed in the bearing holder 39 may rotatably support the screw shaft 38 or rotatably support the shaft 14. Furthermore, the deceleration gear part 27 is not necessarily a two-stage planetary deceleration mechanism, and various deceleration mechanisms may be used.

Further, the embodiments described above illustrate that the actuator 100 is a rod-shaped body including three housings 6 to 8, which are the substantially tubular first housing 6 (corresponding to the first housing in the claims); the substantially tubular second housing 7 (corresponding to the first housing in the claims) having one end 7a (the left end in FIG. 2 and FIG. 3) fitted and fixed to the inner circumferential surface of the first housing 6 at the other end 6b (the right end in FIG. 2 and FIG. 3); and the substantially tubular third housing 8 (corresponding to the second housing in the claims) fitted to the inner circumferential surface of the second housing 7 at the other end 7b so as to protrude therefrom or retract thereinto. However, the disclosure is not limited thereto, and the first housing 6 and the second housing 7 may be integrated into one housing.

What is claimed is:

1. An actuator, comprising:
a first housing, formed in tubular shape;
a second housing, formed in tubular shape and fitted to an inner circumferential surface of the first housing on one end side to protrude from or retract into the first housing;
a motor, disposed in the first housing on the other end side and comprising a rotation shaft;
a drive shaft, disposed in the first housing and the second housing to be driven to rotate by a rotational force of the rotation shaft of the motor;
a driven part, fixed to an inner tube disposed on an inner side of the second housing in a radial direction and linked to the drive shaft to move along an axial direction of the drive shaft along with a rotation of the drive shaft; and
a stopper, disposed on a tip part of the drive shaft on a side opposite to the motor to prevent the driven part from coming off the drive shaft,
wherein the stopper comprises a regulating member that elastically regulates an inclination of the drive shaft with respect to the axial direction, and
the regulating member is constantly in sliding contact with an inner circumferential surface of the inner tube.

2. The actuator according to claim 1, wherein the regulating member is a rubber that is in sliding contact with an entire circumference of the inner circumferential surface of the inner tube.

3. The actuator according to claim 2, comprising a plurality of recesses formed on an outer circumferential surface of the regulating member or a plurality of through holes formed in the regulating member, or comprising both the plurality of recesses and the plurality of through holes.

4. The actuator according to claim 1, comprising a plurality of recesses formed on an outer circumferential surface of the regulating member or a plurality of through holes formed in the regulating member, or comprising both the plurality of recesses and the plurality of through holes.

5. The actuator according to claim 1, wherein the regulating member comprises:
a fixing part, fixed to the tip part of the drive shaft;
a sliding contact part, formed in annular shape to surround a periphery of the fixing part and being in sliding contact with the inner circumferential surface of the inner tube; and
an elastic member, disposed between the fixing part and the sliding contact part.

6. The actuator according to claim 5, wherein the elastic member is a compression coil spring.

7. A vehicle door opening/closing actuator using the actuator according to claim 1 for opening/closing a door that is disposed to open/close an opening.
